(19) United States
(12) Patent Application Publication
(10) Pub. No.: US 2009/0313561 A1
(43) Pub. Date: Dec. 17, 2009

(54) ALPHANUMERIC INPUT ANIMATION

(75) Inventors: Steven Friedlander, San Diego, CA (US); Yuko Nishikawa, La Jolla, CA (US)

Correspondence Address: SONY C/O MURABITO, HAO & BARNES LLP, TWO NORTH MARKET STREET, THIRD FLOOR, SAN JOSE, CA, 95113, US

(73) Assignees: SONY CORPORATION OF JAPAN, Tokyo (JP); SONY ELECTRONICS, INC., Parkridge, NJ (US)

(21) Appl. No.: 12/136,774

(22) Filed: Jun. 11, 2008

(51) Int. Cl. G06F 3/048

(52) U.S. Cl. 715/764

(57) ABSTRACT

Techniques for animation of alphanumeric inputs include generating an animated graphical representation of an alphanumeric input and combining the animated graphical representation with content. The combined animated graphical representation and the content are then output on a monitor.

### BACKGROUND OF THE INVENTION

Electronic devices have made significant contributions towards the advancement of modern society. An ever increasingly important aspect of electronic devices is the user experience. An important part of electronic devices that affects the user experience is the user interface. Electronic devices such as televisions, for example, include an input interface such as a remote control and/or a control panel and a display that makeup the user interface. Typically, a user may enter an alphanumeric input via the remote control as part of an input command to change the channel for instance. The alphanumeric input is typically echoed back to the user on the display. Generally, the display of the alphanumeric input is simply presented as small alphanumeric characters in white font on a black background super imposed on the content currently being displayed. However, this conventional technique is not particularly appealing to the user. Accordingly, there is a continued need for an improved user interface for electronic devices such as televisions that improves the user experience.

### SUMMARY OF THE INVENTION

Embodiments of the present technology are directed toward alphanumeric input animation. In one embodiment, a system includes an input interface, a video processing unit and a display. The input interface generates alphanumeric inputs. The video processing unit generates an animated graphical representation of the alphanumeric inputs and combines the animated graphical representation with content for output on a display.

In another embodiment, a method includes receiving an alphanumeric input from an input interface. An animated graphical representation of the alphanumeric input is generated and combined with content from a content source. The combined animated graphical representation and the content are then output on a display.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 shows a block diagram of a system that includes an alphanumeric input animated interface, in accordance with one embodiment of the present technology.

FIG. 2 shows a flow diagram of an alphanumeric input animation method in accordance with one embodiment of the present technology.

FIGS. 3A-3F show screen shots illustrating a technique for animation of alphanumeric inputs, according to an exemplary implementation of the present technology.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

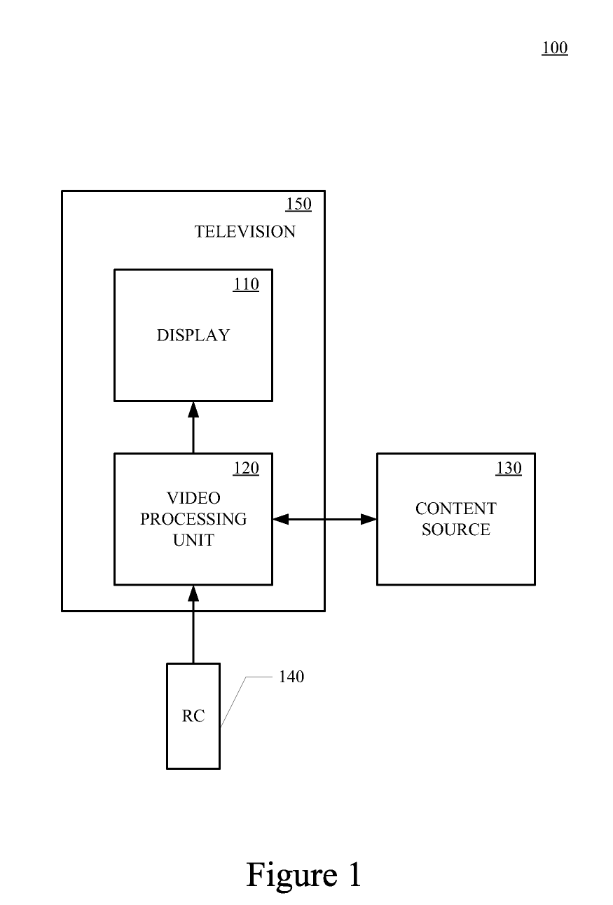

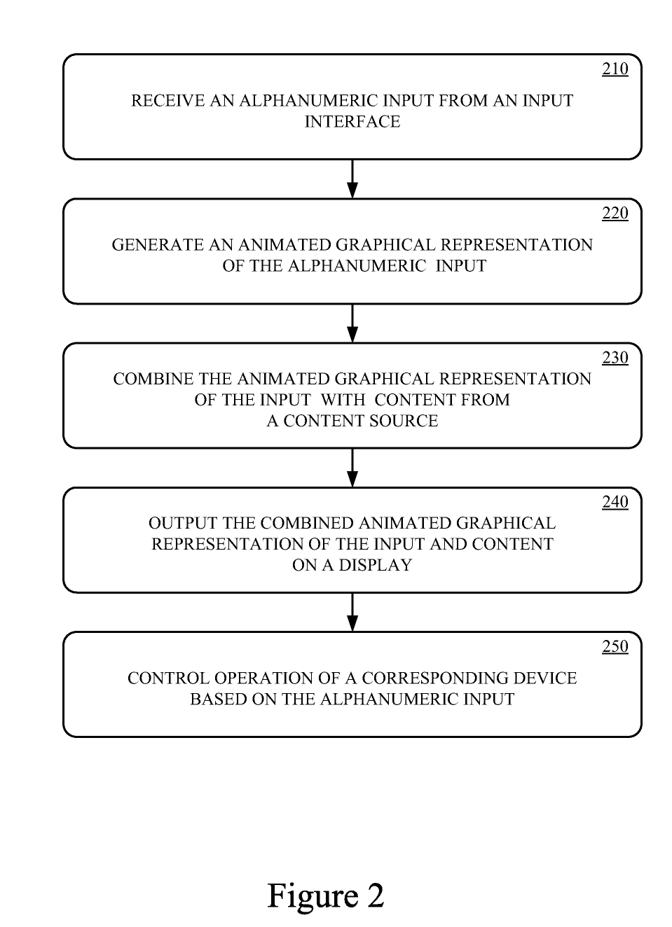

FIG. 1 shows a system that includes an alphanumeric input animated interface, in accordance with one embodiment of the present technology. Operation of the system will be further described with reference to FIG. 2, which shows an alphanumeric input animation method in accordance with one embodiment of the present technology. The system 100 includes a display 110, one or more video processing units 120, one or more content sources 130, and one or more input interfaces 140. Each video processing unit 120 may be implemented in hardware, firmware, and/or by software and a microprocessor (e.g., computing device executable commands and data stored in computing device readable media that when executed by a processing unit implement one or more functions that include the alphanumeric input animation technique).

In an exemplary implementation, the display 110 and a video processing unit 120 may be part of an electronic device such as a television 150 or the like, the content source 130 may be a set top box (STB), digital video disk (DVD) player or the like, and the input interface 140 may be a remote control or the like. However, it is appreciated that the display 110, video processing unit 120, content source 130 and input interface 140 may be arranged in numerous other possible implementations. For example, the video processing unit 120 may be part of one or more content sources 130, or a content source 130 may be part of the television 150. The input interfaces 140 may be a remote control, and/or a control panel on the television 150 or one or more of the content sources 130. Furthermore, each input interface 140 may separately control a respective television 150 or content source 130, and/or at least one of the input interfaces 140 may control a plurality of elements that include the television 150 and/or one or more of the content sources 130.

At 210, an alphanumeric input is received by the video processing unit 120 from an input interface 140. In one implementation, the input may be an alphanumeric input received in response to user activation of one or more buttons on a ten-key pad of a remote control 140. As used herein the term “alphanumeric” is intended to include numbers, letters, and symbols in any one or more of a plurality of languages. At 220, an animated graphical representation of the input is generated by the video processing unit 120. The animated graphical representation of the alphanumeric input may include a graphic of one or more numbers, letters and/or symbols that change in one or more characteristics, such as size, contrast, color, transparency, shading, texture, position, orientation, location, perspective and/or the like, over a period of time. For example, a graphic of a number may start relatively large and get smaller as the number moves from a first position to a second position.

At 230, the animated graphical representation of the input is combined with content from a content source 130 by the video processing unit 120. The animated graphical representation, in one implementation, may be combined by replacing corresponding pixels in the content to be output on the display with the pixels of the animated graphical representation. In another implementation, the corresponding pixels in the content to be output on the display and the pixels of the animated graphical representation are blended. Blending the corresponding pixels results in a partial transparent effect, wherein the content that underlies the animated graphical representation is partially visible through the animated graphical representation. At 240, the combined animated graphical representation of the input and the content are output by the video processing unit 120 on the display 110. In addition, the operation of a device such as the television 150 or content source 130 may be controlled based on the alphanumeric input received from the input interface 140, at 250.

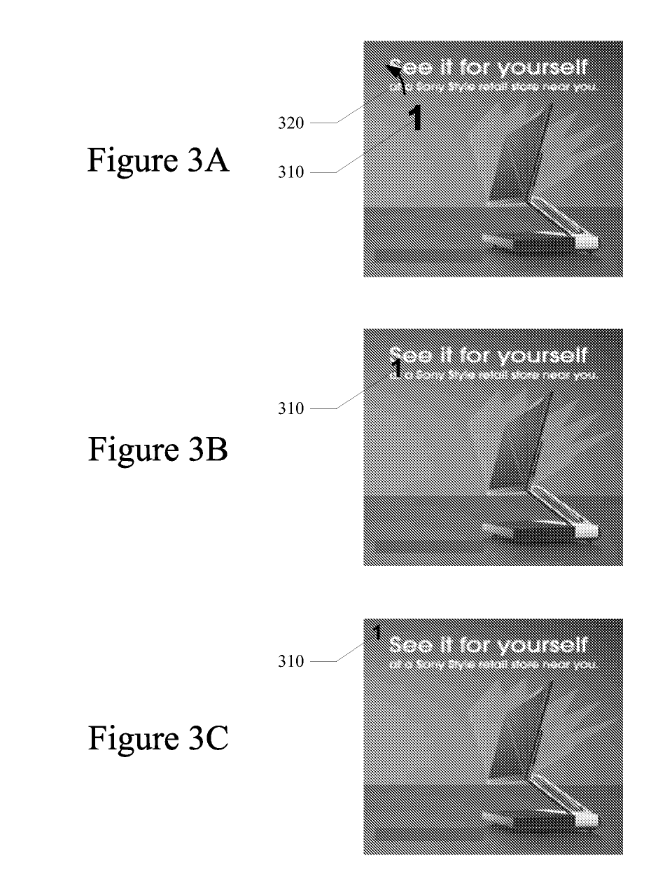

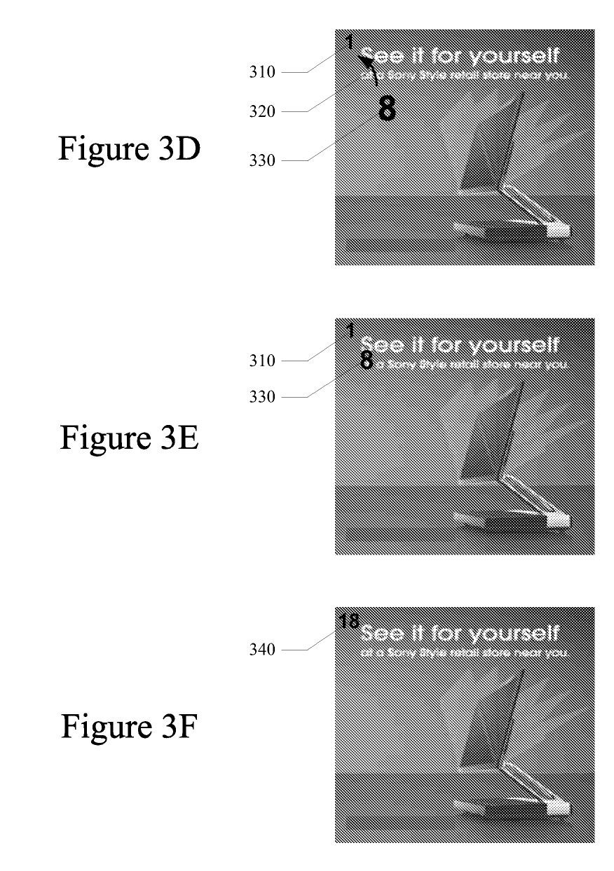

Referring now to FIGS. 3A-3F, an illustration of a technique for animation of alphanumeric inputs, according to an exemplary implementation of the present technology, is shown. As illustrated in FIG. 3A, a graphical representation of a numeric input begins with the input “1” 310 being displayed with an initial size in a first position. The “1” 310 then moves from the first position to a second position as indicated by the arrow labeled 320. As the “1” 310 moves from the first position to a second position the size of the “1” 310 gets smaller, as illustrated in FIG. 3A, 3B and 3C. As illustrated in FIG. 3C, the graphical representation of the numeric input ends with the “1” 310 being displayed with a final size in the second position. The movement and resizing of the “1” may appear as a substantially fluid motion to the user. Accordingly, the alphanumeric input is shown as relatively large, transparent and closer to the middle of the screen and then animates down to its final size and final location in the peripheral region of the screen. In the illustrated implementation, the animated graphical representation of the “1” may create the visual perception of the “1” being thrown up on the screen in response to the user activating the “1” button on the remote control. FIGS. 3D, 3E and 3F then illustrate the display of the graphical representation of an “8” 330 input. Again, the animated graphical representation of the “8” 330 may create the visual perception of the “8” 330 being thrown up on the screen in response to the user activating the “8” button. The input of the “8” 330 may combine with the “1” 310 at the second position to represent the alphanumeric input of “18” 340 on the display confirming the users channel selection command of “18.”

Accordingly, embodiments of the present technology give the user more of an interactive feeling when they are pressing buttons on a remote or other input interface. The animated visual feedback of alphanumeric inputs adds a special effect to enhance the user experience.

The foregoing descriptions of specific embodiments of the present technology have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the Claims appended hereto and their equivalents.

What is claimed is:

1. A system comprising:
an input interface for generating an alphanumeric input;
a video processing unit for generating an animated graphical representation of the alphanumeric input and combining the animated graphical representation with a content; and
a display for outputting the combined animated graphical representation and the content.

2. The system of claim 1, further comprising an electronic device including the video processing unit and the display.

3. The system of claim 2, wherein the electronic device comprises a television.

4. The system of claim 1, further comprising a content source for supplying the content to the video processing unit.

5. The system of claim 4, further comprising an electronic device including the video processing unit and the content source.

6. The system of claim 5, wherein the electronic device is a set top box.

7. The system of claim 5, wherein the electronic device is a digital video disk (DVD) player.

8. A method comprising:
receiving an alphanumeric input from an input interface;
generating an animated graphical representation of the alphanumeric input;
combining the animated graphical representation with content from a content source; and
outputting the combined animated graphical representation and the content on a display.

9. The method according to claim 8, wherein the alphanumeric input consists of one or more of a letter, number and symbol.

10. The method according to claim 8, wherein the alphanumeric input is received in response to user activation of one or more buttons on a remote control.

11. The method according to claim 8, wherein the animated graphical representation comprises a change in one or more characteristics of a graphic of one or more numbers, letters or symbols over time.

12. The method according to claim 9, wherein the one or more characteristics consist of one or more of a size, contrast, color, transparency, shading, texture, position, orientation, location and perspective.

13. The method according to claim 8, wherein the graphical representation comprises an alphanumeric input that changes from a larger size to a smaller size and from a first location to a second location.

14. The method according to claim 8, wherein the animated graphical representation and the content are combined by replacing corresponding pixels in the content with the pixels of the animated graphical representation.

15. The method according to claim 8, wherein the animated graphical representation and the content are combined by blending the corresponding pixels in the content with the pixels of the animated graphical representation.

15. The method according to claim 8, further comprising controlling operation of an electronic device based on the alphanumeric input.

16. One or more computing device readable media for storing computing device executable commands and data which when executed by a processing unit implement a alphanumeric input animation method comprising:
generating an animated graphical representation of an alphanumeric input;
combining the animated graphical representation with a content;
displaying the combined animated graphical representation and the content; and
controlling operation of an electronic device based on the alphanumeric input.

17. The method according to claim 16, wherein the animated graphical representation comprises a change in one or more characteristics of a graphic of one or more numbers, letters or symbols over time.

18. The method according to claim 17, wherein the one or more characteristics consist of one or more of a size, contrast, color, transparency, shading, texture, position, orientation, location and perspective.

19. The method according to claim 16, wherein the animated graphical representation and the content are combined by replacing corresponding pixels in the content with the pixels of the animated graphical representation.

20. The method according to claim 16, wherein the animated graphical representation and the content are combined by blending the corresponding pixels in the content with the pixels of the animated graphical representation.
